(19) United States
(12) Patent Application Publication
(10) Pub. No.: US 2014/0293315 A1
(43) Pub. Date: Oct. 2, 2014

(54) IMAGE PROCESSING DEVICE, IMAGE PROCESSING SYSTEM, AND IMAGE PROCESSING METHOD

(71) Applicant: SEIKO EPSON CORPORATION, Tokyo (JP)

(72) Inventors: Tomotaka TAKARABE, Matsumoto (JP); Kosuke SHINGAI, Matsumoto (JP)

(73) Assignee: SEIKO EPSON CORPORATION, Tokyo (JP)

(21) Appl. No.: 14/218,098

(22) Filed: Mar. 18, 2014

(30) Foreign Application Priority Data
Apr. 2, 2013 (JP) 2013-076629
Aug. 30, 2013 (JP) 2013-179103

(51) Int. Cl. H04N 1/00

(52) U.S. Cl. CPC H04N 1/00854
USPC 358/1.14

(57) ABSTRACT

An image processing device includes a usage request acquiring part, first and second setting parts, a determining part, and an executing part. The first setting part sets first restriction information that shows whether the prescribed function is executable in response to a usage request that includes the authentication information. The second setting part sets second restriction information that shows whether the prescribed function is executable in response to a usage request that does not include the authentication information. The determining part determines whether the prescribed function is executable based on the first restriction information in response to the usage request that includes the authentication information when user authentication is conducted corresponding to the authentication information and the user authentication is established, and determines whether the prescribed function is executable based on the second restriction information in response to the usage request that does not include the authentication information.

### CROSS-REFERENCE TO RELATED APPLICATIONS

This application claims priority to Japanese Patent Application No. 2013-076629 filed on Apr. 2, 2013 and Japanese Patent Application No. 2013-179103 filed on Aug. 30, 2013. The entire disclosures of Japanese Patent Application Nos. 2013-076629 and 2013-179103 are hereby incorporated herein by reference.

### BACKGROUND

1. Technical Field

The present invention relates to an image processing device, an image processing system, and an image processing method, and particularly relates to user authentication.

2. Related Art

Conventionally, in a device having a plurality of functions such as printing, copying, scanning, and fax transmission and reception, usage control conducted by user authentication has been known (for example, Japanese Laid-open Patent Publication No. 2007-208573 and Japanese Laid-open Patent Publication No. 2007-164621).

### SUMMARY

In a case in which a print job is transmitted from a host computer to a printer via a network so as to cause the printer to execute printing, a driver program for the printer to be executed by the host computer includes a driver provided by a third party other than a genuine driver provided by the printer manufacturer. A driver of a third party is created, for example, by obtaining only an image processing module from the printer manufacturer and freely designing a UI (User Interface) by the third party. Sometimes a UI for inputting authentication information (a user name, a password) is not provided in such a driver. As a result, there is a problem that authentication is not approved at all times with respect to a print job transmitted using a driver created by a third party and a user of the driver cannot use functions of the printer at all times.

The object of the present invention is to improve convenience of a usage request from a device in which authentication information cannot be input while activating a user authentication function.

An image processing device according to one aspect includes a usage request acquiring part, first and second setting parts, a determining part, and an executing part. The usage request acquiring part is configured to acquire a usage request for a prescribed function that includes authentication information of a user or a usage request for a prescribed function that does not include the authentication information. The first setting part is configured to set first restriction information that shows whether or not the prescribed function is executable in response to the usage request that includes the authentication information. The second setting part is configured to set second restriction information that shows whether or not the prescribed function is executable in response to the usage request that does not include the authentication information. The determining part is configured to determine whether or not the prescribed function is executable based on the first restriction information in response to the usage request that includes the authentication information when user authentication is conducted corresponding to the authentication information and the user authentication is established, and to determine whether or not the prescribed function is executable based on the second restriction information in response to the usage request that does not include the authentication information. The executing part is configured to execute the prescribed function that has been determined to be executable.

With the aspect having the above-described configuration, it is possible to improve convenience of a usage request from a device in which authentication information cannot be input while activating user authentication. That is, in a case in which a usage request for a prescribed function that includes authentication information is acquired from a device that issues the request, user authentication is conducted, and when the user authentication is established, it is determined whether or not the prescribed function is executable based on the first restriction information. When it is determined to be executable, the prescribed function can be executed in response to the usage request. Also, in a case in which a usage request for a prescribed function that does not include authentication information is acquired from a device that issues the request, even if user authentication is conducted, the user authentication will not be established because no authentication information is included. However, it is determined whether or not the prescribed function is executable based on the second restriction information instead of conducting user authentication, and when it is determined to be executable, the prescribed function can be executed in response to the usage request. Conventionally, user authentication is conducted regardless of whether authentication information is included or not. Therefore, in a case in which authentication information is not included, it is considered that authentication is not established at all times, and the prescribed function cannot be executed. However, by employing the configuration of the present invention, it is possible to select whether or not the prescribed function is executed based on the second restriction information even in a case in which a usage request that does not include authentication information is acquired.

Further, in the image processing device for achieving the above-described object, the first restriction information may be defined for each of a plurality of functions.

In a case in which the image processing device has a plurality of functions, by defining the first restriction information for each of the plurality of functions with respect to each user, more detailed settings on whether or not the function is executable are possible compared to a case in which the same content of the first restriction information is defined for any one of the plurality of functions. Here, the first restriction information defined for each of the plurality of functions may be defined for each client, or may be defined for each group that includes one or more users. Further, it is sufficient for the first restriction information to be information that shows whether or not an optional function of an authentic user is executable, and various embodiments are conceivable. For example, the first restriction information may be information that only shows whether or not the function is executable, may be information that shows the number of times (number of pages) for a use limit per unit time or the like, or may be information that defines restriction regarding various detailed functions.

Further, in the image processing device for achieving the above-described object, the second restriction information may be defined for each of a plurality of functions.

In a case in which the image processing device has a plurality of functions, by defining the second restriction information for each of the plurality of functions with respect to each user, more detailed settings on whether or not the function is executable are possible compared to a case in which the same content of the second restriction information is defined for any one of the plurality of functions. Here, it is sufficient for the second restriction information to be information that shows whether or not a function is executable in response to a usage request that does not include authentication information, and various embodiments are conceivable. For example, the second restriction information may be information that only shows whether or not the function is executable, may be information that shows a the number of times (number of pages) for a use limit per unit time or the like in response to the usage request that does not include authentication information, or may be information that defines restriction regarding various detailed functions.

Further, the image processing device for achieving the above-described object may include a log storing part that stores a log of a usage request that has not been determined to be executable by the determining part.

In this case, a user of the image processing device or an administrator of the image processing device can check information regarding a usage request that has not been determined to be executable later.

Further, in the image processing device for achieving the above-described object, the log storing part may store the log by separating a usage request (a) that includes the authentication information in which the user authentication has not been established, a usage request (b) that includes the authentication information and has not been determined to be executable based on the first restriction information although the user authentication has been established, and a usage request (c) that does not include the authentication information and has not been determined to be executable based on the second restriction information.

By storing the usage request (a), (b), and (c) in a distinguishable manner, an administrator of the image processing device can easily analyze or count a usage request that has not been determined to be executable.

In order to achieve the above-described object, an image processing system includes the above-described image processing device, and an information processing device configured to transmit a usage request that includes the authentication information to the image processing device. The information processing device includes an authentication information receiving part configured to receive input of the authentication information, an execution instruction receiving part configured to receive execution instructions of the prescribed function, and a usage requesting part configured to transmit the authentication information as the usage request to the image processing device together with an execution command of the prescribed function that corresponds to the execution instructions.

By transmitting the execution command together with the authentication information as the usage request from the information processing device to the image processing device, the procedure can be made simple in a case of transmitting a usage request from the information processing device to the image processing device.

In order to achieve the above-described object, an image processing system includes the above-described image processing device, and an information processing device configured to transmit a usage request that includes the authentication information to the image processing device. The information processing device includes an authentication information receiving part configured to receive input of the authentication information, an execution instruction receiving part configured to receive execution instructions of the prescribed function, a usage requesting part configured to transmit a usage request for the prescribed function that includes the authentication information to the image processing device prior to an execution command of the prescribed function that corresponds to the execution instructions, a result obtaining part configured to obtain determination results based on the authentication information from the image processing device, and an execution commanding part configured to transmit the execution command to the image processing device in a case in which the determination results show that the prescribed function is executable. The image processing device includes a result notifying part configured to transmit the determination results by the determining part to the information processing device, and an execution command acquiring part configured to acquire the execution command from the information processing device. The executing part executes the prescribed function that has been determined to be executable in response to the execution command.

In this case, the authentication information is transmitted from the information processing device to the image processing device prior to the execution command of the prescribed function, and the information processing device can obtain the determination results prior to the execution command of the prescribed function. As a result, it is possible to arrange that the execution command is not transmitted in a case in which the prescribed function cannot be used according to the determination results, or notify a user of the fact that the prescribed function cannot be used according to the determination results.

Further, the above-described technique for user authentication or determination of whether or not a prescribed function is executable can be implemented also as an image processing method, a program for controlling an image processing device, or a program for controlling an information processing program.

Also, there are cases in which the above-described system, device, program, or method is achieved by a single device, and there are cases in which it is achieved by using common parts in a device of complex functions. The above-described system, device, program, or method includes various kinds of embodiments.

### BRIEF DESCRIPTION OF THE DRAWINGS

Referring now to the attached drawings which form a part of this original disclosure:

FIG. 1 is a block diagram that shows a configuration of an image processing system according to an embodiment of the present invention.

FIGS. 2A to 2D are diagrams that show data configurations according to a first embodiment of the present invention.

FIG. 3 is a flow chart of a print process according to the first embodiment of the present invention.

FIGS. 4A to 4C are diagrams that show data configurations according to another embodiment of the present invention.

### DETAILED DESCRIPTION OF EXEMPLARY EMBODIMENTS

Hereinafter, embodiments of the present invention will be explained with reference to the attached drawings.

### 1. First Embodiment

### 1-1. Configuration

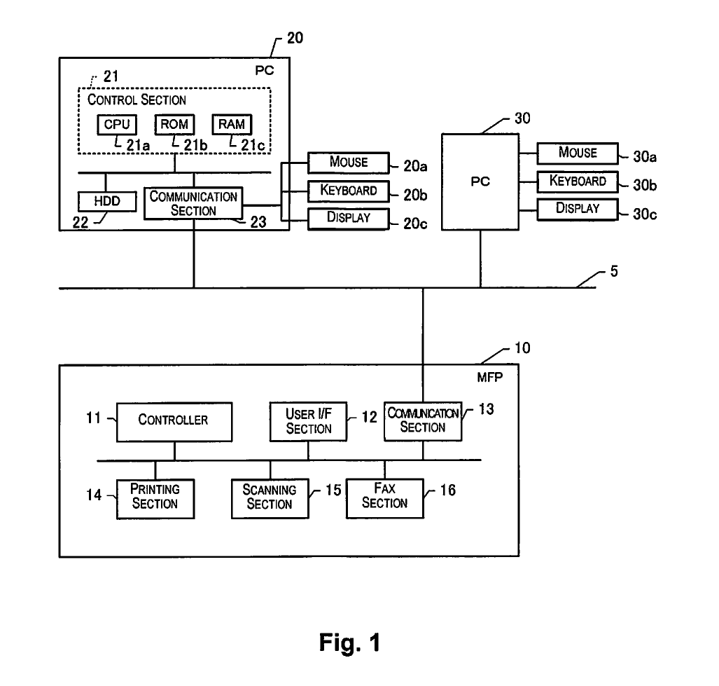

FIG. 1 is a block diagram that shows a configuration of an image processing system according to an embodiment of the present invention.

The image processing system has an MFP (Multi-Function Printer) 10 as the “image processing device” and a PC (Personal Computer) 20 as the “information processing device”. The MFP 10 has multiple functions including a print function, a scan function, a facsimile (FAX) function, and the like. The MFP 10 is connected to a host computer such as the PC 20 or a PC 30 via a network such as a LAN 5. The MFP 10 is configured to receive a request for execution of various functions such as printing, scanning, or FAX transmission from the PC 20 or 30 and execute the function when it is determined to be executable by determination described below.

The MFP 10 has a controller 11, a user I/F section 12, a communication section 13, a printing section 14, a scanning section 15, and a FAX section 16. The controller 11 is constructed of a non-volatile memory, a RAM, an ASIC, and the like. The controller 11 can control the entire MFP 10 by causing a CPU to execute various programs stored in the non-volatile memory. More specifically, the controller 11 conducts various types of communication by controlling the communication section 13. The communication section 13 includes an interface circuit and the like for establishing wireless LAN communication or wired LAN communication.

When the controller 11 acquires a print job by the communication section 13, the controller 11 executes printing by controlling the printing section 14 based on the acquired print job. The printing section 14 is provided with an actuator, a sensor, a drive circuit and a mechanical component for executing printing onto a printing medium such as photographic paper, plain paper, OHP sheet by a well-known printing method such as an ink-jet system, or an electrophotographic system. The User I/F section 12 is provided with a touch panel display, various operation keys, and the like.

Also, when the controller 11 acquires an execution command of scanning by the communication section 13, the controller 11 causes the scanning section 15 to read a document placed on a document table by controlling the scanning section 15, so that the scan data obtained by reading can be stored in the non-volatile memory or the like. The controller 11 can output the scan data to a device such as a PC, that has transmitted the execution command of scanning, by controlling the communication section 13. The scanning section 15 is provided with a well-known color image sensor that makes scanned image data by emitting light towards a document placed on the document table and decomposing light reflected from the document into each color of RGB, and an actuator, a drive circuit and a mechanical component for feeding the document.

Also, the FAX section 16 is provided with a modem for transmitting and receiving FAX data via a telephone line, a circuit for detecting or generating a control signal to transmit and receive FAX data, a circuit for decoding received FAX data or encoding FAX data to be transmitted, and the like. The FAX section 16 stores FAX data received from the telephone line in the non-volatile memory or the like. When the controller 11 acquires an execution command of FAX transmission or FAX data for transmission by the communication section 13, the controller 11 sends the FAX data for transmission to the telephone line by controlling the FAX section 16.

The PC 20 is provided with a control section 21, an HDD (Hard Disk Drive) 22, a communication section 23, and the like. The control section 21 is provided with a CPU 21a, a ROM 21b, a RAM 21c, and the like. The CPU 21a can execute various kinds of programs recorded in the ROM 21b or the HDD 22 by loading such programs in the RAM 21c. The communication section 23 is provided with an interface circuit and the like for conducting wired LAN communication or wireless LAN communication. The communication section 23 is provided with an interface circuit for conducting wired or wireless communication with peripheral devices such as a mouse 20a, a keyboard 20b, a display 20c, or the like.

Since the PC 30 has a similar configuration to the PC 20, overlapped explanations will be omitted. The PC 20 and the PC 30 have a driver program (Print-Dr) for using the print function of the MFP 10, a driver program (Scan-Dr) for using the scan function of the MFP 10, and an application program (Fax-Ap) for using the FAX transmission function of the MFP 10, that are installed therein. As the Print-Dr, the Scan-Dr, and the Fax-Ap, there are ones created and provided by the manufacturer of the MFP 10, and ones created and provided by a third party other than the manufacturer of the MFP 10. The MFP 10 of the present embodiment has a user authentication function, and a UI (User Interface) for asking a user to input the user ID and the password is provided in the Print-Dr, the Scan-Dr, and the Fax-Ap created by the manufacturer of the MFP 10. On the other hand, a UI for asking a user to input the user ID and the password is not provided in the Print-Dr, the Scan-Dr, the Fax-Ap created by a third-party. In the present embodiment, the following explanations will be made on the assumption that the Print-Dr, the Scan-Dr, and the Fax-Ap created by the manufacturer of the MFP 10 are installed in the PC 20, and the Print-Dr, the Scan-Dr, and the Fax-Ap created by a third party are installed in the PC 30.

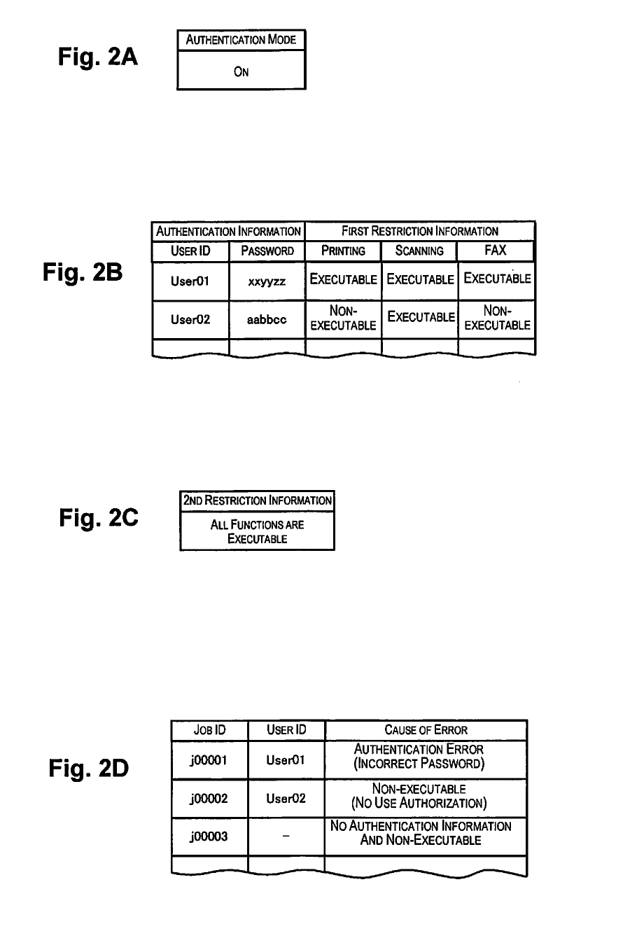

As shown in FIG. 2A, a set value of the authentication mode is stored in the non-volatile memory of the controller 11 of the MFP 10 in advance. A value that shows whether to activate or deactivate the user authentication function in the MFP 10 is set for the authentication mode. In a case in which the user authentication function is deactivated, the use of the MFP 10 is allowed for all users without any use restriction. A case in which the user authentication function is activated will be described in detail later. The administrator of the MFP 10 can input the set value of the authentication mode by operating the user I/F section 12 or the like in advance. Further, as shown in FIG. 2B, authentication information of an authentic user of the MFP 10 and first restriction information are stored in the non-volatile memory of the controller 11 in advance with established correspondence. The authentication information includes a user ID and a password. The first restriction information is information that defines a value showing whether or not each function of the MFP 10 is executable for each user. The authentication information is registered with the MFP 10 in advance by each user or the administrator of the MFP 10, and the first restriction information is registered with the MFP 10 in advance by the administrator of the MFP 10. Further, as shown in FIG. 2C, second restriction information is stored in advance in the non-volatile memory of the controller 11. The second restriction information is information that defines the behavior of the MFP 10 in a case in which the authentication information is not included in a usage request for the function of the MFP 10. In the present embodiment, the second restriction information is information that defines whether all functions of the MFP 10 are made collectively executable or collectively non-executable. The set value of the second restriction information is set in advance in the MFP 10 by the administrator of the MFP 10. The controller 11 that stores such information in the non-volatile memory corresponds to the “first setting part” and the “second setting part”.

### 1-2. Print Process

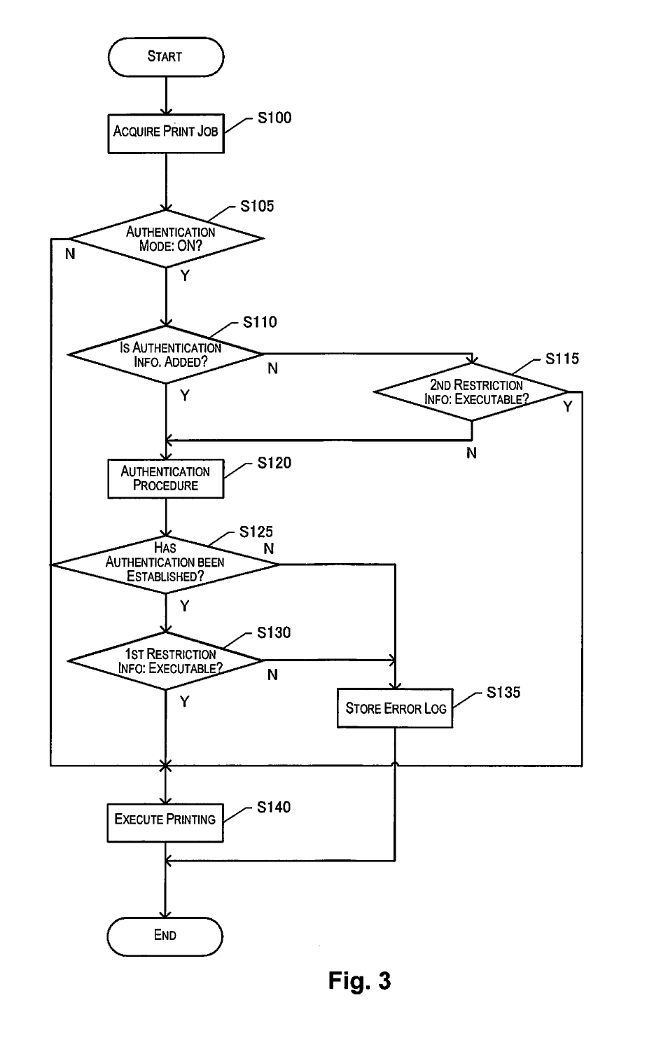

FIG. 3 is a flow chart that shows a print process executed by the controller 11 in a case in which the MFP 10 acquires a print job from the host computer such as the PC 20 or the PC 30. For example, in a case in which a user of the PC 20 wishes to use the print function of the MFP 10, the user of the PC 20 conducts a prescribed operation for starting the Print-Dr of the MFP 10 on the PC 20.

Since a UI for inputting authentication information is provided in the Print-Dr installed in the PC 20, the user inputs the user ID and the password from the UI. Then, the print job is transmitted from the PC 20 to the MFP 10 by inputting print conditions and the like, and operating the UI such as a print button (by conducting an execution instruction operation for printing). Here, the control section 21 serves as the “authentication information receiving part” and the “execution instruction receiving part” when it receives input of the authentication information or an operation of the print button. Further, the control section 21 and the communication section 23 serve as the “usage requesting part” when they transmit a print job. The print job transmitted from the PC 20 includes a tag of the authentication information and the tag includes the user name and the password of a user who requested printing. The print job also includes an execution command to execute printing in accordance with the print conditions and print target data. The print job transmitted from the PC 20 or the PC 30 to the MFP 10 corresponds to the “usage request”. The controller 11 and the communication section 13 serve as the “usage request acquiring part” when they acquire a print job.

For example, when a user of the PC 30 wishes to use the print function of the MFP 10, the user of the PC 30 conducts a prescribed operation for starting the Print-Dr of the MFP 10 on the PC 30. The Print-Dr installed in the PC 30 is not provided with a UI for inputting authentication information. Therefore, when the user inputs the print conditions and the like, and operates the UI such as a print button without inputting the authentication information, the print job is transmitted from the PC 30 to the MFP 10. The tag itself of the authentication information is not included in the print job transmitted from the PC 30.

When the controller 11 acquires the print job from the host computer (step S100), the controller 11 determines whether the authentication mode has been set to ON (the user authentication function is activated) or not (step S105). In a case in which it is not determined that the authentication mode has been set to ON in step S105 (that is, the user authentication function is deactivated), the process proceeds to step S140. That is, printing is conducted without any use restriction. The controller 11 serves as the “determining part” when it executes the processes of steps S105-S130.

In a case in which it is determined that the authentication mode has been set to ON in step S105, the controller 11 determines whether the authentication information is added to the print job or not (step S110). In a case in which it is not determined that the authentication information is added, the controller 11 determines whether a value showing that the print function is executable when the authentication information is not added is set in the second restriction information (step S115). When it is not set to be executable, the process proceeds to step S120, and when it is set to be executable, the process proceeds to step S140. It may also be possible to directly proceed to step S135 when it is determined that it is not set to be executable in step S115. This is because the process goes through step S115 when it is determined that the authentication information is not added, and it is always determined that the authentication has not been established in step S125 when it is not determined that it is set to be executable in step S 115, which results in proceeding to step S135.

In a case in which it is determined that the authentication information is added in step S110, the controller 11 conducts the authentication procedure (step S120). Specifically, the controller 11 checks the authentication information added to the print job against the authentication information of FIG. 2B stored in the non-volatile memory, and determines whether or not both the user ID and the password match with any one of the stored authentication information. When the combination of the user ID and the password that is included in the print job matches with any one of the combination of the user ID and the password that is stored, the authentication is established and the user who transmitted the print job is determined as an authentic user of the MFP 10. When the combination of the user ID and the password that is included in the print job does not match with any one of the combination of the user ID and the password that is stored, the authentication is not established and the user is determined as a non-authentic user. In a case in which the authentication procedure of step S120 is executed by way of step S115, it is always determined that the authentication is not established because the authentication information is not included in the print job.

Subsequently, the controller 11 determines whether the authentication is established or not (step S125). In a case in which the controller 11 determines that the authentication is established, the controller 11 determines whether the user who transmitted the print job can execute the print function by referring to the first restriction information (step S130). In a case in which the controller 11 determines that the user who transmitted the print job can execute the print function, the controller 11 determines that the print job is executable and executes printing by controlling the printing section 14 (step S140). In this case, the controller 11 and the printing section 14 serve as the “executing part”. In a case in which it is not determined that the authentication is established in step S125 or in a case in which it is not determined that the user can execute the print function in step S 130, the controller 11 stores a log of errors (printing cannot be executed) in the non-volatile memory of the controller 11 without executing printing (step S135), and ends the print process. The controller 11 serves as the “log storing part” when it conducts the log storing process of step S135. For example, as shown in FIG. 2D, the error log in the present embodiment is stored such that the cause of errors can be identified. Specifically, the cause of errors that can be identified includes a situation in which printing cannot be executed because the authentication is not established although the authentication information is included in the print job, a situation in which printing cannot be executed because it is determined that there is no use authorization based on the first restriction information although the authentication information is included in the print job and the authentication is established, and a situation in which printing cannot be executed because the tag of the authentication information is not included in the print job and all functions are set to be non-executable in the second restriction information. As a result, the administrator can easily analyze or count the errors.

The second restriction information of the present embodiment is used when the authentication information is not included in the usage request for the function of the MFP 10. A usage request from a device such as the PC 30 in which authentication information cannot be input is conceivable as the “usage request that does not include authentication information”, and the example includes a print job that does not include a tag of authentication information.

Here, a case in which a usage request from a device such as the PC 20 provided with a UI for inputting authentication information does not include a user name or a password is assumed. Even if a user name or a password is not included, a print job from the PC 20 includes the tag of authentication information as described above. Therefore, a print job from the PC 20 is different from a print job from the PC 30. That is, the controller 11 can identify whether or not the usage request includes authentication information based on the presence or absence of the tag of the authentication information when applying the second restriction information. A print job that includes the tag of authentication information is recognized as a usage request that includes authentication information even if a user name or a password is not included, and the second restriction information is not applied.

As described above, according to the present embodiment, it is possible to improve the convenience regarding a usage request from a device such as the PC 30 in which authentication information cannot be input while activating the user authentication function. That is, when a usage request for a prescribed function that includes authentication information is acquired, user authentication is conducted, and when the user authentication is established, it is determined whether the prescribed function is executable based on the first restriction information. When it is determined that the prescribed function is executable, the prescribed function can be executed in response to the usage request. Also, when a usage request for a prescribed function that does not include authentication information, even if user authentication is conducted, the user authentication will not be able to be established because the authentication information is not included. However, it can be determined whether or not the prescribed function is executable based on the second restriction information instead of conducting user authentication, and when it is determined that the prescribed function is executable, the prescribed function can be executed in response to the usage request. Conventionally, user authentication is conducted regardless of whether authentication information is included or not. Therefore, in a case in which authentication information is not included, it is considered that authentication is not established at all times, and the prescribed function cannot be executed. However, in the present embodiment, it is possible to select whether or not the prescribed function is executed based on the second restriction information even in a case in which a usage request that does not include authentication information is acquired.

### 2. Other Embodiment

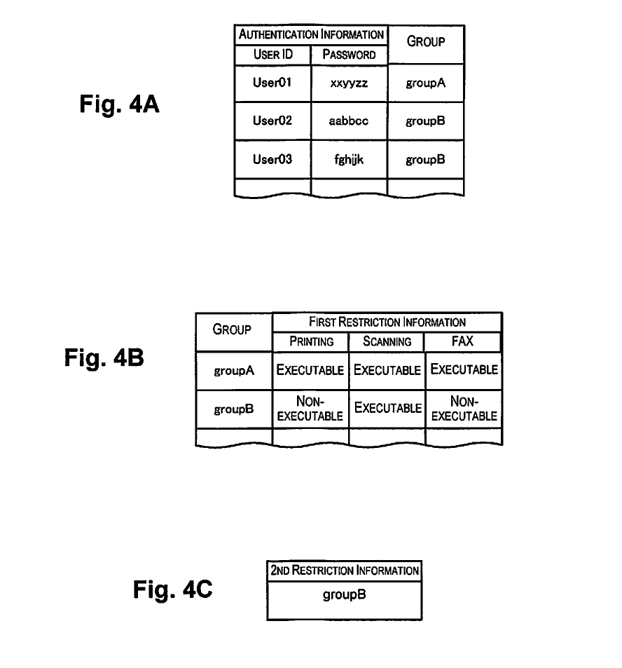

The technical scope of the present invention is not limited to the above-described embodiment, and it is apparent that various changes can be made without departing from the subject matter of the present invention. For example, in the above-described embodiment, the second restriction information is information for collectively setting the availability of all functions. However, it may be information for setting the availability of each function. For example, as shown in FIG. 4A, each user may be arranged to belong to any group, and as shown in FIG. 4B, the availability of each function may be defined for each group. Then, as shown in FIG. 4C, in the second restriction information, the same set value may be used as one in any of the groups shown in FIG. 4B.

Further, although a print process is explained in the above-described embodiment, the present invention can be applied to a scan process or a FAX transmission process. For example, when a user wishes to use the scan function and conducts a prescribed operation for starting the Scan-Dr on the PC 20, the control section 21 starts the Scan-Dr. When the user inputs authentication information from the UI of the Scan-Dr, the control section 21 receives the input of the authentication information (authentication information receiving part). When the user sets a document on the document table and conducts a scan instruction operation using the UI of the Scan-Dr, the control section 21 receives the scan instruction operation (execution instruction receiving part) and the control section 21 controls the communication section 23 to send the authentication information as a “usage request” along with an execution command of pre-scanning (usage requesting part). When the MFP 10 acquires the usage request (usage request acquiring part), the MFP 10 determines whether or not the scan function is available based on the user authentication and the first restriction information (determining part), sends the determination results to the PC 20 (result notifying part), and conducts pre-scanning. The control section 21 obtains the determination result though the communication section 23 (result obtaining part). When the scan function is available according to the determination results, the control section 21 transmits an execution command for actual scanning to the MFP 10 (execution commanding part). When the MFP 10 acquires the execution command for actual scanning (execution command acquiring part), the MFP 10 executes actual scanning (executing part). In a case in which actual scanning cannot be executed for a reason such as authentication error or no authorization as described above, it is possible to notify the PC 20 of that effect before the PC 20 transmits an execution command for actual scanning to the MFP 10.

Next, a case in which a user of the PC 20 uses the FAX transmission function will be explained. For example, a UI for inputting authentication information may be provided in the start process of the Fax-Ap. Then, when the user inputs authentication information, the control section 21 receives the authentication information (authentication information receiving part), the control section 21 transmits the authentication information to the MFP 10 as a “usage request” in the process of starting the Fax-Ap (usage requesting part). The MFP 10 determines whether or not the FAX transmission function is available based on the user authentication and the first restriction information (determining part), and transmits the determination results to the PC 20 (result notifying part). The control section 21 receives the determination results from the MFP 10 (result obtaining part). When the FAX transmission function is available according to the determination results, the control section 21 completes the start-up of the Fax-Ap, and displays a UI for inputting various conditions of the FAX transmission and a UI for instructing to start transmission. When the user inputs the various conditions and operates the UI for instructing to start transmission, the control section 21 receives the operation (execution instruction receiving part), and transmits an execution command for the FAX transmission to the MFP 10 (execution commanding part). When the MFP 10 receives the execution command for the FAX transmission (execution command acquiring part), the MFP 10 controls the FAX section 16 to execute the FAX transmission (executing part).

In a case in which the FAX transmission function cannot be executed for a reason such as authentication error or no authorization as described above, it is possible to notify the PC 20 of that effect in the process of starting the Fax-Ap. When the PC 20 is notified of the effect that the FAX transmission function cannot be executed, the PC 20 can notify the user of that effect and terminates the starting process of the FAX-Ap in the middle. As described above, the PC 20 can obtain the determination results based on the user authentication and the first control information before transmitting an execution command for actual scanning or an execution command for FAX transmission, and it is thus possible to notify the user of the effect that the function cannot be executed as soon as possible.

Another configuration may be possible, in which a first authentication mode for setting whether or not to conduct authentication can be set with respect to both of a usage request that includes authentication information and a usage request that does not include authentication information, a second authentication mode for setting whether or not to conduct authentication only for a usage request that does not include authentication information can be set, the controller 11 does not conduct user authentication for a usage request by determining that the usage request does not include authentication information in a case in which the second authentication mode is set to be deactivated even if the first authentication mode is set to be activated, and conducts user authentication for a usage request that includes authentication information. In the former case, since user authentication is not conducted, all the functions of a plurality of functions can be made available. However, user authentication may be conducted for a usage request that includes authentication information. Further, in a case in which both of the first authentication mode and the second authentication mode are set to be activated, user authentication may be conducted for a usage request that does not include authentication information and the results may be determined as an authentication error. As a process for the authentication error, it is preferable to make all the functions unavailable, but some functions may be made available.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

1. An image processing device comprising:
a usage request acquiring part configured to acquire a usage request for a prescribed function that includes authentication information of a user or a usage request for a prescribed function that does not include the authentication information;
a first setting part configured to set first restriction information that shows whether or not the prescribed function is executable in response to the usage request that includes the authentication information;
a second setting part configured to set second restriction information that shows whether or not the prescribed function is executable in response to the usage request that does not include the authentication information;
a determining part configured to determine whether or not the prescribed function is executable based on the first restriction information in response to the usage request that includes the authentication information when user authentication is conducted corresponding to the authentication information and the user authentication is established, and to determine whether or not the prescribed function is executable based on the second restriction information in response to the usage request that does not include the authentication information; and
an executing part configured to execute the prescribed function that has been determined to be executable.

2. The image processing device according to claim 1, further comprising
a log storing part configured to store a log of the usage request that has not been determined to be executable by the determining part.

3. The image processing device according to claim 2, wherein
the log storing part is configured to store the log by separating the usage request that includes the authentication information in which the user authentication has not been established, the usage request that includes the authentication information and has not been determined to be executable based on the first restriction information although the user authentication has been established, and the usage request that does not include the authentication information and has not been determined to be executable based on the second restriction information.

4. An image processing system comprising:
the image processing device according to claim 1; and
an information processing device configured to transmit the usage request that includes the authentication information to the image processing device, wherein
the information processing device includes
an authentication information receiving part configured to receive input of the authentication information,
an execution instruction receiving part configured to receive execution instructions of the prescribed function, and
a usage requesting part configured to transmit the authentication information as the usage request to the image processing device together with an execution command of the prescribed function that corresponds to the execution instructions.

5. An image processing system comprising:
the image processing device according to claim 1; and
an information processing device configured to transmit the usage request that includes the authentication information to the image processing device, wherein
the information processing device includes
an authentication information receiving part configured to receive input of the authentication information,
an execution instruction receiving part configured to receive execution instructions of the prescribed function,
a usage requesting part configured to transmit the usage request for the prescribed function that includes the authentication information to the image processing device prior to an execution command of the prescribed function that corresponds to the execution instructions,
a result obtaining part configured to obtain determination results based on the authentication information from the image processing device, and
an execution commanding part configured to transmit the execution command to the image processing device in a case in which the determination results show that the prescribed function is executable,
the image processing device further includes
a result notifying part configured to transmit the determination results by the determining part to the information processing device, and
an execution command acquiring part configured to acquire the execution command from the information processing device,
wherein the executing part is configured to execute the prescribed function that has been determined to be executable in response to the execution command.

6. An image processing method comprising:
acquiring a usage request for a prescribed function that includes authentication information of a user or a usage request for a prescribed function that does not include the authentication information;
setting first restriction information that shows whether or not the prescribed function is executable in response to the usage request that includes the authentication information;
setting second restriction information that shows whether or not the prescribed function is executable in response to the usage request that does not include the authentication information;
determining whether or not the prescribed function is executable based on the first restriction information in response to the usage request that includes the authentication information when user authentication is conducted corresponding to the authentication information and the user authentication is established, and determining whether or not the prescribed function is executable based on the second restriction information in response to the usage request that does not include the authentication information; and
executing the prescribed function that has been determined to be executable.

7. An image processing device comprising:
a usage request acquiring part configured to acquire a usage request for a prescribed function that includes authentication information of a user or a usage request for a prescribed function that does not include the authentication information;
a first authentication mode setting part configured to set activation or deactivation of a first authentication mode regarding the usage request that includes the authentication information and the usage request that does not include the authentication information;
a second authentication mode setting part configured to set activation or deactivation of a second authentication mode regarding the usage request that does not include the authentication information; and
a controller configured to conduct user authentication in response to the usage request that includes the authentication information in a case in which the first authentication mode is set to be activated and the second authentication mode is set to be deactivated, and the controller being configured not to conduct user authentication in response to the usage request that does not include the authentication information in a case in which the first authentication mode is set to be activated and the second authentication mode is set to be deactivated and all functions are made available, and at least part of the prescribed function is made unavailable in a case in which the first authentication mode and the second authentication are set to be activated.
